(19) United States
(12) Patent Application Publication
(10) Pub. No.: US 2008/0299266 A1
(43) Pub. Date: Dec. 4, 2008

(54) Containers

(75) Inventors: Raymond Clarke, Los Altos, CA (US); David Taft, Atherton, CA (US)

Correspondence Address: SHELDON MAK ROSE & ANDERSON PC, 100 Corson Street, Third Floor, PASADENA, CA, 91103-3842, US

(73) Assignee: APIO, INC., Guadelupe, CA (US)

(21) Appl. No.: 10/596,754

(22) PCT Filed: Dec. 21, 2004
(86) PCT No.: PCT/US2004/042832

§ 371 Date: Aug. 20, 2008

Related U.S. Application Data
(60) Provisional application No. 60/532,025, filed on Dec. 22, 2003.

(51) Int. Cl. B65D 81/18; B65D 81/24; A23L 3/00; B32B 27/00

(52) U.S. Cl. 426/118; 426/395; 428/339

(57) ABSTRACT

Respiring biological materials can be stored in a sealed container having (i) an interior surface at least partly composed of a hydrophilic polymer composition and (ii) an auxiliary component through which oxygen and carbon dioxide can enter or leave the packaging atmosphere within the container.

### CROSS-REFERENCE TO RELATED APPLICATION

This application claims priority from U.S. Provisional Application No. 60/532,025, filed Dec. 22, 2003, the entire disclosure of which is incorporated by reference herein for all purposes.

### BACKGROUND OF THE INVENTION

This invention relates to the packaging of respiring biological materials, and other situations in which control of the gases in an atmosphere is desirable.

Respiring biological materials, e.g. fruits and vegetables, consume oxygen (O₂) and produce carbon dioxide (CO₂) at rates which depend upon the stage of their development, the atmosphere surrounding them and the temperature. In modified atmosphere packaging (MAP), the objective is to produce a desired packaging atmosphere around respiring materials by placing them in a sealed container whose permeability to O₂ and CO_{2 produces} the desired packaging atmosphere. Often, the container includes at least one atmosphere control member (ACM) having a high O₂ transmission rate (OTR) and a high CO₂ transmission rate (COTR). In controlled atmosphere packaging (CAP), the objective is to produce a desired packaging atmosphere by displacing some or all of the air within a sealed container by one or more gases, e.g. nitrogen, O₂, CO₂ and ethylene, in desired proportions.

For further details of MAP and CAP, reference may be made, for example, to U.S. Pat. Nos. 3,360,380 (Bedrosian), 3,450,542 (Badran), 3,450,544 (Badran et al.), 3,798,333 (Cummin et al), 3,924,010 (Erb), 4,003,728 (Rath), 4,734,324 (Hill), 4,779,524 (Wade), 4,830,863 (Jones), 4,842,875 (Anderson), 4,879,078 (Antoon), 4,910,032 (Antoon), 4,923,703 (Antoon), 4,987,745 (Harris), 5,041,290 (Wallace et al.) 5,045,331 (Antoon), 5,063,753 (Woodruff), 5,160,768 (Antoon), 5,254,354 (Stewart), 5,333,394 (Herdeman), 5,433,335 (Raudalus et al.), 5,443,851 (Christie et al.), 5,460,841 (Herdeman), 5,556,658 (Raudalus et al.), 5,658,607 (Herdeman), 5,807,630 (Christie et al.), 5,832,699 (Zobel), 5,872,721 (Huston et al.), 6,013,293 (De Moor), 6,190,710 (Nir et al), 6,210,724 (Clarke et al.), 6,296,923 (Zobel), 6,376,032 (Clarke et al.) and 6,548,132 (Clarke et al.); copending commonly assigned U.S. patent application Ser. Nos. 09/121,082 (Clarke et al.), 09/580,379 (Clarke), 09/858,190 (Clarke), 09/989,682 (Clarke), 09/999,600 (Clarke), 60/435,567 (Clarke et al.), 60/532,025 (Clarke), 60/539,949 (Clarke) and 60/540,121 (Clarke et al.); the International application filed by Apio Inc., Clarke and Tompkins on December 13, 2004, claiming priority from U.S. patent application Nos. 60/540,121 and 60/539,949; US Patent Application Publication Nos. US 2002/0127305 (Clarke) and 2003/0057217 (Wyslotsky); International Publication Nos. WO 94/12040 (Fresh Western), WO 96/38495 (Landec), WO 00/04787 (Landec), WO 01/92118 (Landec) and WO 03/043447 (Landec); and European Patent Applications Nos. 0,351,115 and 0,351,116 (Courtaulds). The disclosure of each of those patents, applications and publications is incorporated herein by reference for all purposes.

U.S. Pat. No. 6,190,710 discloses a sealed container which contains a respiring biological material and which is composed of a perforated film of nylon-6 or a like polymer, in order to minimize condensation of water inside the container.

### SUMMARY OF THE INVENTION

In a first aspect, this invention provides an improved container which
(a) has an interior surface at least part of which is composed of a hydrophilic polymer composition (HPC) as defined below, and
(b) comprises an auxiliary component comprising a second polymeric composition (i) which is not an HPC, and (ii) through which, when the container is sealed around a respiring biological material and a packaging atmosphere around the respiring biological material, pass oxygen and carbon dioxide entering or leaving the packaging atmosphere.
   The term “hydrophilic polymer composition” (often abbreviated herein to HPC) is used herein to denote a polymeric composition which, in the form of a film consisting of the polymeric composition and immersed in water at 23° C., has an equilibrium water content of at least 4.0%, preferably at least 6.0%, particularly at least 8%, by weight, based on the dry weight of the composition.

The container of the first aspect of the invention can be an open container which can be sealed around contents of any kind; or a container which is sealed around contents of any kind; or a container which was once sealed around contents of any kind, and which has been unsealed, and which may or may not still contain the contents which were within it when it was sealed. The invention is particularly, but not exclusively, useful when the contents are respiring biological materials.

In a second aspect, this invention provides a method of storing a respiring biological material wherein the biological material is stored in a packaging atmosphere within a sealed container according to the first aspect of the invention.

In a third aspect, this invention provides a novel laminate which can for example be used in the preparation of a container according to the first aspect of the invention and which
(a) comprises a first layer composed of an HPC composition and a second layer which is composed of a second polymeric composition which is not an HPC composition, and
(b) has a moisture vapor transmission rate (MVTR) of 50 to 250, e.g. 150 to 250, preferably 100 to 220, particularly 140 to 200, g/m².hr

### DETAILED DESCRIPTION OF THE INVENTION

In the Summary of the Invention above and in the Detailed Description of the Invention, and the claims below, reference is made to particular features (including method steps) of the invention. It is to be understood that the disclosure of the invention in this specification includes all appropriate combinations of such particular features. For example, where a particular feature is disclosed in the context of a particular aspect, embodiment or claim of the invention, that feature can also be used, to the extent appropriate, in combination with and/or in the context of other particular aspects, embodiments and claims of the invention, and in the invention generally.

In describing and claiming the invention below, the following abbreviations, definitions, and methods of measurement (in addition to those already given) are used.

OTR is O₂ permeability. COTR is CO₂ permeability. OTR and COTR values are given in ml/m².atm.24 hr, with the equivalent in cc/100 in².atm.24 hr in parentheses, and can be measured using a permeability cell (supplied by Millipore) in which a mixture of O₂, CO₂ and helium is applied to the sample, using a pressure of 0.035 kg/cm² (0.5 psi), and the gases passing through the sample are analyzed for O₂ and CO₂ by a gas chromatograph. The cell could be placed in a water bath to control the temperature. P₁₀ is the ratio of the permeability, to O₂ or CO₂ as specified, at a first temperature T₁° C. to the permeability at a second temperature T₂, where T₂ is (T₁-10)° C. T₁ being 10° C. and T₂ being 0° C. unless otherwise noted. R or R ratio is the ratio of COTR to OTR, both permeabilities being measured at 20° C. unless otherwise noted. Pore sizes are measured by mercury porosimetry. Parts and percentages are by weight, except for percentages of gases, which are by volume. Temperatures are in degrees Centigrade. For crystalline polymers, Tₒ is the onset of melting, Tₚ is the crystalline melting point, and ΔH is the heat of fusion. Tₒ, Tₚ and ΔH are measured by means of a differential scanning calorimeter (DSC) at a rate of 10° C./minute and on the second heating cycle. Tₒ and Tₚ are measured in the conventional way well known to those skilled in the art. Thus Tₚ is the temperature at the peak of the DSC curve, and Tₒ is the temperature at the intersection of the baseline of the DSC peak and the onset line, the onset line being defined as the tangent to the steepest part of the DSC curve below Tₚ. Moisture vapor transmission rate (MVTR) values are given herein in units of g./m².24 hr., for example measured in accordance with ASTM E96 at 38° C.

The terms “a”, “and” and “the” before an item are used herein to mean that there can be a single such item or two or more such items, unless the context makes this impossible. For example, where reference is made to a container including an auxiliary component, this includes the possibility that the container includes a single auxiliary component or a plurality of auxiliary components.

The term “comprises” and grammatical equivalents thereof are used herein to mean that other elements (i.e. components, ingredients, steps etc.) are optionally present. For example, a composition “comprising” (or “which comprises”) ingredients A, B and C can contain only ingredients A, B and C, or can contain not only ingredients A, B and C but also one or more other ingredients. Similarly, references herein to “the ACM” or “an ACM” are intended to include two or more ACM's on the same package. The term “consisting essentially of” and grammatical equivalents thereof is used herein to mean that other elements may be present which do not materially alter the invention. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility. The term “at least” followed by a number is used herein to denote the start of a range beginning with that number (which may be a range having an upper limit or no upper limit, depending on the variable being defined). For example “at least 1” means 1 or more than 1, and “at least 80%” means 80% or more than 80%. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number)”, this means a range whose lower limit is the first number and whose upper limit is the second number. For example, “from 8 to 20 carbon atoms” or “8-20 carbon atoms” means a range whose lower limit is 8 carbon atoms, and whose upper limit is 20 carbon atoms. The numbers given herein should be construed with the latitude appropriate to their context and expression.

Where reference is made herein to sealed packages and sealed containers, and to sealing bags and other containers, it is to be understood that the sealing can be, but need not be, hermetic sealing. Conventional methods for sealing bags and other containers can conveniently be used in this invention. If the container is sealed hermetically, it will generally be desirable to include one or more apertures in the container, the size of the apertures being sufficient to achieve equilibration of the pressures inside and outside the container, but preferably without substantially changing the permeability of the container as a whole to oxygen, carbon dioxide and water vapor.

### Hydrophilic Polymer Compositions (HPCs)

The term Hydrophilic Polymer Composition (HPC) is defined above. Additionally, a film consisting of an HPC, when exposed at 23° C. to an atmosphere having a relative humidity of 50%, may have an equilibrium water content of at least 1.0%, preferably at least 2.0%, particularly at least 2.4%, by weight, based on the dry weight of the film. Such testing can if desired be carried out using, for example, a specimen in the form of a disc having a diameter of about 51 mm (2 in) and a thickness of 3-6 mm (0.125-0.250 in), for example in accordance with ASTM D570. The HPC may have a water permeability of more than 1.5 g/mm.m².24 hr at 38° C. and 85-90% relative humidity.

HPCs useful in the present invention includes plastic packaging materials disclosed in U.S. Pat. No. 6,190,710, in particular polyamides (including polyamides derived from two or more different monomers and/or having two or more different repeating units), for example nylon-6, nylon-66, nylon-610, nylon-612 and nylon 666. Typically, but not necessarily, the HPC is in the form of a film (including a film which is a layer in a laminate including one or more other layers, which may or may not be HPCs). The moisture vapor transmission of a particular film depends not only on the MVTR of the material of the film, but also the thickness and area of the film. The MVTR of a material does not determine the oxygen and carbon dioxide levels of the packaging atmosphere within a container made of such material.

Films having a high MVTR typically also have a low permeability to oxygen and carbon dioxide, for example an OTR of less than 1550 (100) or less than 1085 (70) and/or a COTR value less than 4650 (300) or less than 3875 (250). The presence of perforations in such films increases the permeability of the film to oxygen and/or carbon dioxide. However, because the perforations are equally permeable to oxygen and carbon dioxide, the sum of the oxygen and carbon dioxide contents of the packaging atmosphere is about 21%. For the storage of many materials, this is not satisfactory.

Where reference is made herein to HPC's, it is to be understood that this term is intended to include polymeric compositions which are HPC's as defined and which comprise a polymeric component composed of (i) a single HPC or (ii) a mixture of two or more HPCs or (iii) a mixture of one or more HPCs with one or more non-HPCs. For example, an HPC can be blended with a non-HPC (e.g. a polyamide can be mixed with an olefin polymer) to produce a composition having a lower MVTR, e.g. an MVTR which is 0.5 to 0.9 times the MVTR of the HPC alone, for example an MVTR of 50 to 250, e.g. 150 to 250, preferably 100 to 220, particularly 140 to 200. The compositions can include, in addition to the polymeric component, conventional non-polymeric additives, e.g. fillers and stabilizers

The HPC can comprise a homopolymer or a copolymer comprising repeating units containing, in the backbone and/or in side chains, groups having an affinity for water. Such polymers include polyamides, including nylon-6, nylon-66, nylon-6/66 and nylon-6-12; cellulosic polymers; polyesters; polyurethanes; polyvinyl alcohol; polylactic acid; and polymers containing substantial proportions of functional groups such as amide, hydroxyl, carboxyl, acyl, anhydride, amino, monoalkyl amino and dialkyl amino groups. The HPC can also comprise a polymer whose water absorbency results from (i) the presence of a filler which is water-absorbent by reason of its chemical and/or physical structure (e.g. starch, zeolites, and nanotechnology fillers), and/or (ii) suitable porosity. The surface of the HPC can optionally be treated to modify its surface tension so that moisture vapor condensed thereon forms a smooth film.

When the HPC is in the form of a self-supporting film, the film may for example have a thickness of 10 to 200 micron, preferably 15 to 30 micron. When the HPC is in the form of a layer in a multi-layer laminate, the or each HPC layer may for example have a thickness of 3 to 30 micron. The other layer or layers in the laminate can be polymeric or non-polymeric. In some embodiments, the or one of the other layers is composed of a non-HPC material and has a lower MVTR than the HPC layer(s) and thus controls the MVTR of the laminate. For example, the other layer can be a very thin layer of an olefin polymer.

The self-supporting HPC film or HPC-containing laminate can be, but preferably is not, treated to modify its permeability to water vapor and/or oxygen and/or carbon dioxide, and can be, but preferably is not, perforated

### Auxiliary Components

The containers used in the present invention comprise an auxiliary component which comprises a non-HPC polymeric material, and through which pass oxygen and carbon dioxide entering or leaving the packaging atmosphere within the sealed container. The auxiliary component preferably has at least one of the following characteristics
(a) it has an R ratio greater than 1, for example at least 1.5, e.g. 2 to 5, for example 2 to 4;
(b) it has a P₁₀ ratio greater than 1, for example at least 1.3;
(c) it comprises an atmosphere control member (ACM) comprising a microporous film having a coating of the polymer thereon, the polymer coated on the microporous film preferably being selected from one or both of (i) a side chain crystalline (SCC) polymer, e.g. a block copolymer in which one of the blocks is an SCC polymer and the other block is a polysiloxane block, and (ii) an amorphous polymer, e.g. a polysiloxane,
(d) it provides at least 50%, for example at least 80% or at least 95%, e.g. 98 to substantially all, of the total oxygen permeability of the sealed container;
(e) it is part of a laminate comprising a first layer composed of the HPC and a second layer composed of the second polymeric composition, the second layer optionally having one or more of the following characteristics
(i) it is less than 10, e.g. 2-6, micron thick,
   (ii) it is composed of a polyolefin, for example an ethylene polymer,
   (iii) it is part of a three-layer laminate and is sandwiched between the first layer and a third layer, for example a third layer composed of an HPC, and
   (iv) it has an MVTR of 50 to 250, e.g. 150 to 250, preferably 100 to 220, particularly 140 to 200;
(f) it is a discrete element, for example an ACM as defined above or a film composed of a non-HPC material, for example a discrete element covering a window in a film composed of an HPC, or a wide-mouthed bag composed of the non-HPC film whose mouth is closed by an HPC film; and
(g) a ratio of ethylene permeability to oxygen permeability greater than 1, for example 2 to 5, e.g. about 4 (this is important when the respiring biological material is to be ripened in the sealed container by exposure to ethylene).

The containers of the invention preferably include an auxiliary component which is an ACM as disclosed in one of the documents incorporated herein by reference and which has an R ratio greater than 1, e.g. 1-5, e.g. about 4. The ACM can be used in conjunction with one or more other auxiliary components, for example an auxiliary component which is part of the laminate.

When the auxiliary component is part of a laminate, the laminate can provide part or all of the container and can be, but preferably is not, the only part of the container through which passes the oxygen, carbon dioxide and moisture vapor entering or leaving the packaging atmosphere. Such a laminate can be, but preferably is not, perforated through all the layers, after the laminar member has been assembled. Optionally, one or more of the layers can be perforated before the laminar member is assembled. The perforations can be large perforations, so that the perforated layer contributes to the physical strength of the laminar member, but not to its gas transmission properties of the laminar member, which are determined by the layer or layers covering the large perforations.

### ACM's

The principal function of the ACM's preferably used in this invention is to provide a means for obtaining a package having desired permeabilities to particular gases, in particular oxygen and carbon dioxide, and, in some cases (for example when ripening fruits which are ripened by exposure to ethylene, particularly bananas) to ethylene. Thus the ACM will generally provide at least 50%, for example at least 80%, preferably at least 95%, e.g. 98-100%, of the total oxygen permeability and/or the total ethylene permeability of the package. The ACM can also make a small contribution, e.g. less than 10%, for example 3 to 8%, to the total permeability of the container to moisture vapor. The ACM can for example be selected so that the packaging atmosphere has a combined oxygen and carbon dioxide content of less than 18%, for example an oxygen content of 2-12% or 2-5% and a carbon dioxide content of 3-15% or 5-10%.

In the ACM's preferably used in the present invention, the microporous polymeric film, which serves as a support for the polymeric coating, comprises a network of interconnected pores such that gases can pass through the film. Preferably the pores have an average pore size of less than 0.24 micron. Other optional features of the microporous film include
(a) at least 70%, e.g. at least 90%, of the pores having a pore size of less than 0.24 micron;
(b) at least 80% of the pores have a pore size less than 0.15 micron;
(c) less than 20% of the pores have a pore size less than 0.014 micron;
(d) the pores constitute 35 to 80% by volume of the microporous film;
(e) the microporous film comprises a polymeric matrix comprising (i) an essentially linear ultrahigh molecular weight polyethylene having an intrinsic viscosity of at least 18 deciliters/g, or (ii) an essentially linear ultrahigh molecular weight polypropylene having an intrinsic viscosity of at least 6 deciliters/g, or (iii) a mixture of (i) and (ii);
(f) the microporous film contains 30 to 90% by weight, based on the weight of the film, of a finely divided particulate substantially insoluble filler, preferably a siliceous filler, which is distributed throughout the film;
(e) the microporous film is prepared by a process comprising
   (A) preparing a uniform mixture comprising the polymeric matrix material in the form of a powder, the filler, and a processing oil;
   (B) extruding the mixture as a continuous sheet;
   (C) forwarding the continuous sheet, without drawing, to a pair of heated calender rolls;
   (D) passing the continuous sheet through the calender rolls to form a sheet of lesser thickness;
   (E) passing the sheet from step (D) to a first extraction zone in which the processing oil is substantially removed by extraction with an organic extraction liquid which is a good solvent for the processing oil, a poor solvent for the polymeric matrix material, and more volatile than the processing oil;
   (F) passing the sheet from step (E) to a second extraction zone in which the organic extraction liquid is substantially removed by steam or water or both; and
   (G) passing the sheet from step (F) through a forced air dryer to remove a residual water and organic extraction liquid.
      Suitable microporous films are available under the tradename Teslin.

The polymeric matrix of the coating on the microporous film can comprise a crystalline polymer, preferably an SCC polymer. The use of a crystalline polymer results in an increase in the P₁₀ values in the melting region of the polymer. The SCC polymer can comprise, and optionally can consist of, units derived from (i) at least one n-alkyl acrylate or methacrylate (or equivalent monomer, for example an amide) in which the n-alkyl group contains at least 12 carbon atoms, e.g. 12-50 carbon atoms, for example in amount 35-100%, preferably 50-100%, often 80-100%, and optionally (ii) one or more comonomers selected from acrylic acid, methacrylic acid, and esters of acrylic or methacrylic acid in which the esterifying group contains less than 10 carbon atoms. The SCC polymer can also include units derived from a diacrylate or other crosslinking monomer. The preferred number of carbon atoms in the alkyl group of the units derived from (i) depends upon the desired melting point of the polymer. For the packaging of biological materials, it is often preferred to use a polymer having a relatively low melting point, for example a polymer in which at least a majority of the alkyl groups in the units are derived from (i) and contain 12 and/or 14 carbon atoms. The SCC polymer can be a block copolymer in which one of blocks is a crystalline polymer as defined and the other block(s) is crystalline or amorphous, for example a block copolymer comprising (i) polysiloxane polymeric blocks, and (ii) crystalline polymeric blocks having a Tₚ of −5 to 40° C. SCC polymers can be prepared by solution polymerization or by emulsion polymerization, e.g. as disclosed in U.S. Pat. Nos. 6,199,318 and 6,540,984 (Stewart et al) the entire disclosures of which are incorporated herein by reference.

The polymeric matrix can also consist of or contain other crystalline and amorphous polymers. Examples of such other polymers include cis-polybutadiene, poly (4-methylpentene), and amorphous polymers, for example polysiloxanes including polydimethyl siloxane, and ethylene-propylene rubber.

The permeability of the containers and packages of the invention can be influenced by perforating the container in order to make a plurality of pinholes therein.

### Containers

The containers of the present invention can be of any shape or size appropriate to the materials to be packaged. Often, an important reason for using an HPC will be to ensure that the contents of the sealed package are fully visible, for example in a retail store. In those circumstances, the HPC will provide at least part of a transparent panel in the container. In some embodiments of the invention, the container is a simple bag composed of a flexible film consisting essentially of, or containing an interior layer of, a polymeric composition comprising an HPC, and having an ACM covering an aperture in the bag. In other embodiments, the container comprises a relatively rigid container base having a well in which the biological material is placed, and a top member which comprises an HPC and is sealed to the top of the base. The container base, which may for example be thermoformed, can be composed of a polymeric composition or another material; the polymeric composition of the base can also comprise an HPC, or any other polymer whose permeability to oxygen, carbon dioxide and water vapor is appropriate to the desired packaging atmosphere. The top member can be a flexible film comprising the HPC, or a shaped member, for example a thermoformed member, comprising the HPC. Preferably, at least one of the container base and top includes an ACM covering an aperture therein. In one embodiment which is particularly, but not exclusively, useful for packaging bananas, the container base is a flexible polymeric bag, e.g. a polyethylene bag, supported by a relatively rigid support member, e.g. a cardboard box, for example by folding the neck of the bag over the top of the box.

When a container is composed of different parts, the container as a whole has permeabilities to oxygen, carbon dioxide and water vapor which depend upon the sum of the permeabilities of the different parts of the container (which in turn depend upon the OTR, COTR, MVTR, thickness and area of the different parts of the container). Therefore, when the HPC is in the form of a self-supporting film, its COTR, COTR and MVTR are factors in determining the packaging atmosphere within the sealed package; but they are not the only factors (and may not be significant factors at all), because there are other parts of the container through which at least one of oxygen, carbon dioxide and moisture vapor can enter or leave the packaging atmosphere. When the HPC is part of a multilayer laminar structure, one or more of its OTR, COTR and MVTR may also be factors in determining the composition of the packaging atmosphere. Thus, depending on the relative OTR, COTR and MVTR values of the HPC and of the other layer(s), and the thicknesses of the different layers, the permeabilities of the multilayer laminar structure to oxygen, carbon dioxide and moisture vapor may be respectively dominated by only one of the layers.

### Biological Materials

The present invention can be used for packaging of all types of respiring biological materials, including fruits, vegetables, cut flowers and plants, including for example bananas and green beans. The amount of material within the container can vary widely. The amount may be, for example at least 0.2 kg (0.5 lb), e.g. at least 0.9 kg (2 lb), for example 0.2 to 5 kg (0.5 to 10 lb), e.g. 1 to 2 (2 to 4 lb). The amount can also be much larger, for example up to 22 kg (50 lb) or even more, e.g. up to 90 kg (200 lb). The invention is particularly valuable for packaging bananas, which may be freshly harvested green bananas, or bananas which have been transported, for example over a period of 4-14 days, and are still green; or bananas which are approaching, or have passed, their climacteric, including bananas which have been exposed to ethylene (either before being placed in the sealed container or after being placed in the sealed container while green). Thus in one embodiment, the sealed bag contains unripe bananas, which can then be ripened in the sealed container, and optionally placed on retail sale in the sealed container.

Through the use of the present invention, it is possible to reduce the maximum and/or average temperature of the bananas or other biologically respiring material while it is being stored (including ripened). Another advantage of the present invention is that by controlling the moisture vapor transmission of the container, desiccation of the contents of the container can be reduced or substantially eliminated. This is important, for example, when storing bananas. For example, if bananas are stored in a container having excessive moisture vapor transmission, desiccation of the crown of the bananas can cause the bananas to lose their fresh appearance and to appear old, which is a serious commercial disadvantage.

### EXAMPLES

The invention is illustrated in the following examples, in which the following abbreviations are used.

PE a transparent polyolefin film which has a thickness of about 50 micron (2 mil), an MVTR of about 12 and an OTR of about 4650 (300).
Capran a transparent nylon-6 film which is available from Honeywell under the tradename Capran 1500; and which has a thickness of about 15 micron (0.6 mil), an MVTR of about 267 and an OTR of about 30 (2).
PFX a transparent three-layer laminate which has an MVTR of about 170; and which is believed to be composed of a layer 3-5 micron thick of a polyolefin sandwiched between two layers of nylon-6.
Bag P/Q a bag made by cutting one or more windows in a bag composed of PE and sealing Capran over the window(s) so that the surface of the bag is P % Capran and Q % PE, the values of P and Q being specified in individual Examples
Alloy X/Y a transparent (but slightly cloudy) film which is composed of an alloy of nylon-6 (X %) and polyethylene (Y %), the values of X and Y being specified in individual Examples; and which has a thickness of about 25 micron (1 mil). Alloy 75/25 has an MVTR of about 170. Alloy 85/15 has an MVTR of about 290.
ACM(S) an atmosphere control member which is composed of a microporous film having a coating thereon of an SCC/polysiloxane block copolymer as disclosed in Example A7 of U.S. Pat. No. 6,548,132; and which has an MVTR of about 1720 and an OTR of about 5.000,000 (324,000).

### Example 1

Bananas were packaged in (A) sealed bags composed of Capran, and (B) bags composed of PE. Each bag was about 300×510 mm (12×20 in.); had a circular aperture of area about 1,135 mm² (1.76 in²) covered by an ACM(S); and content about 1.35 kg (3 lb) of green unripened bananas. After 3 days, the sealed bags were exposed to ethylene in a ripening room, and then maintained at about 14.5° C. (58° F.) for 5 days, after which they were stored at 21° C. (70° F.). Condensation in the bags; pulp temperature and appearance of the bananas; and packaging atmosphere, were monitored over a period of 13 days. In the Capran bags, there was substantially no condensation; the bananas could be viewed clearly throughout the test; and the pulp temperature reached a peak of about 22.5° C. (72.5° F.). In the PE bags, condensation within the bag made it difficult to view the bananas clearly; the pulp temperature reached a peak of about 24.2° C. (75.5° F.); and, after the eighth day, remained above 23.3° C. (74° F.). The quality of the bananas in the Capran bags was superior to the quality of the bananas in the PE bags.

### Example 2

Bananas were packaged in (A) sealed bags composed of Capran, (B) sealed bags composed of PE, and (C) sealed bags P/Q in which P/Q was 20/80, 40/60, 60/40 or 80/20. Each bag was about 300×510 mm (12×20 in.), had a circular aperture of area about 1,135 mm² (1.76 in²) covered by an ACM(S) about 60×60 mm (2.35×2.35 in), and contained about 1.35 kg (3 lb) of green unripened bananas. The sealed bags were maintained at about 14.5° C. (58° F.) for 7 days. The table below shows the percentage weight loss of the bananas at the end of the seven days. There was no condensation in the Capran bags, but desiccation of the crowns of the bananas made them look old. There was no desiccation of the crowns of the bananas in the PE bags, but condensation within the bags made it difficult to view the bananas through the bags. The other bags showed a balance between these two extremes, with the best results being shown by the Bag 60/40 and Bag 80/20 bags, in which there was no or very little condensation and the bananas retained a fresh appearance.

Bag

| | PE | 20/80 | 40/60 | 60/40 | 80/20 | Capran |
|---|---|---|---|---|---|---|
| Wt loss | 0.43 | 0.64 | 0.81 | 1.3 | 1.42 | 1.77 |

### Example 3

Bananas were packaged in (A) sealed bags composed of PE, (B) sealed bags composed of PFX, and (C) open bags composed of PE. Each of the sealed bags was about 325×480 mm (12.75×19 in.), and had a circular aperture of area about 1,135 mm² (1.76 in²) covered by an ACM (S) is about 60×60 mm (2.35×2.35 in). Each bag contained about 1.35 kg (3 lb) of green unripened bananas and was maintained at about 14.5° C. (58° F.) for 11 days. The relative humidity on the fifth day was about 95% in the PE bags and about 93% in the PFX bags. The table below shows the average (over 45 bags) percentage weight loss of the bananas at the end of the 11 days. There was no desiccation of the crowns of the bananas in the sealed PFX and PE bags and the bananas retained a fresh appearance. Desiccation of the crowns of the bananas in the open bags made them look old. There was no or very little condensation in the PFX bags and the open bags, but condensation within the PE bags made it difficult to view the bananas through the bags.

| Bag | PE | PFX | open |
|---|---|---|---|
| Wt loss | 0.73 | 1.5 | 4.25 |

### Example 4

Bananas were packaged in (A) sealed bags composed of PE, (B)) sealed bags composed of Alloy 85/15, (C) a sealed bags composed of Alloy 75/25, and (D) open bags composed of PE. Each of the sealed bags was about 325×480 mm (12.75×19 in.), and had a circular aperture of area about 1,135 mm² (1.76 in²) covered by an ACM(S) about 60×60 mm (2.35×2.35 in). Each bag contained about 1.35 kg (3 lb) of green unripened bananas. The bags were maintained at about 14.5° C. (58° F.) for 13 days. The table below shows the average (over 3 bags) relative humidity (RH) at day 6, and the percentage weight loss of the bananas at day 6 and at day 13. There was no desiccation of the crowns of the bananas in the sealed PE, Alloy 85/15 and Alloy 75/25 bags and the bananas retained a fresh appearance. Desiccation of the crowns of the bananas in the open bags made them look old. There was no or very little condensation in the Alloy 85/15, Alloy 75/25 and open bags, but condensation within the PE bags made it difficult to view the bananas through the bags.

| | PE | Alloy 85/15 | Alloy 75/25 | Open |
|---|---|---|---|---|
| Day 6 RH | 96 | 81 | 84 | 78 |
| Day 6 Wt loss | 0.4 | 1.5 | 0.9 | 3.6 |
| Day 13 Wt loss | 1.6 | 5.8 | 4.5 | 13.2 |

### Example 5

A bag 230×300 mm (9×12 in) composed of Capran 1500 includes a circular aperture of area about 1,135 mm² (1.76 in.²) covered by an ACM(S). The bag has an MVTR of about 36.5 g/24 hr (about 34.5 g/24 hr from the Capran and about 2 g/24 hr from the ACM) and an oxygen permeability of about 700,000 cc/24 hr (about 99.92% through the ACM).

1. A method of storing a respiring biological material wherein the respiring biological material is stored in a packaging atmosphere within a sealed container which
(a) has an interior surface at least part of which is composed of a hydrophilic polymer composition (HPC), and
(b) comprises an auxiliary component comprising a second polymeric composition (i) which is not an HPC, and (ii) through which pass oxygen and carbon dioxide entering or leaving the packaging atmosphere.

2. A method according to claim 1 which has at least one of the following characteristics
(a) the auxiliary component has an R ratio of at least 1.5;
(b) the auxiliary component has a P₁₀ ratio of at least 1.3;
(c) the auxiliary component comprises an atmosphere control member (ACM) comprising a microporous film having a coating of the polymer thereon
(d) the auxiliary component is part of a laminate comprising a first layer composed of the HPC and a second layer composed of the second polymeric composition, the second layer having one or more of the following characteristics
(i) it is less than 10 micron thick,
(ii) it is composed of a polyolefin,
(iii) it is part of a three-layer laminate and is sandwiched between the first layer and a third layer, and
(iv) it has an MVTR of 50 to 250

3. A method according to claim 1 wherein the HPC is in the form of a film having a window therein, and the auxiliary component covers the window.

4. A method according to claim 1 wherein the container comprises at least one first discrete section composed of the HPC and at least one second discrete section composed of the second polymeric composition.

5. A method according to claim 1 wherein the HPC provides at least 50% of the interior surface of sealed container.

6. A method according to claim 1 wherein the packaging has an oxygen content of 2-5% and a carbon dioxide content of 5-10%.

7. A method according to claim 1 wherein the HPC composition comprises a polyamide.

8. A method according to claim 1 wherein a film consisting of the HPC, when immersed in water at 23° C., has an equilibrium water content of at least 6.0% by weight based on the dry weight of the composition.

9. A method according to claim 1 wherein a film consisting of the HPC, when exposed at 23° C. to an atmosphere having a relative humidity of 50%, has an equilibrium water content of e.g. at least 2.4%, by weight, based on the dry weight of the composition.

10. A method according to claim 1 wherein the respiring biological material is bananas.

11. A sealable container which, when sealed around a respiring biological material, is suitable for use in the method of claim 1 and which
(a) has an interior surface at least part of which is composed of a hydrophilic polymer composition (HPC), and
(b) comprises an auxiliary component comprising a second polymeric composition (i) which is not an HPC, and (ii) through which pass oxygen and carbon dioxide entering or leaving the packaging atmosphere.

12. A sealed container which is suitable for use in the method of claim 1 and which
(a) has an interior surface at least part of which is composed of a hydrophilic polymer composition (HPC), and
(b) comprises an auxiliary component comprising a second polymeric composition (i) which is not an HPC, and (ii) through which pass oxygen and carbon dioxide entering or leaving the packaging atmosphere.

13. A laminate which is suitable for use in a container as defined in claim 11 and which
(a) comprises a first layer composed of an HPC and a second layer which is composed of a second polymeric composition which is not an HPC, and
(b) has a thickness such that its moisture vapor transmission rate is 50 to 250.

14. A laminate according to claim 13 wherein
the second layer has one or more of the following characteristics
(i) it is less than 10 micron thick,
(ii) it is composed of an olefin polymer, and
(iii) it is part of a three-layer laminate and is sandwiched between the first layer and a third layer composed of an HPC.

15. A method according to claim 1 wherein the HPC comprises polylactic acid.

16. A sealable container according to claim 11 wherein the HPC comprises polylactic acid.

17. A sealed container according to claim 12 wherein the HPC comprises polylactic acid.

18. a laminate according to claim 13 wherein the HPC comprises polylactic acid.
